(19) United States
(12) Patent Application Publication
(10) Pub. No.: US 2006/0022362 A1
(43) Pub. Date: Feb. 2, 2006

(54) Apparatus for monitoring corrosion of extruder components during operation, and processes incorporating such apparatus

(76) Inventors: Robert B. Fish JR., Parkersburg, WV (US); Robert L. Freed, West Chester, PA (US); Brian J. Saldanha, Bear, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/189,890

(22) Filed: Jul. 26, 2005

Related U.S. Application Data
(60) Provisional application No. 60/591,531, filed on Jul. 27, 2004.

(51) Int. Cl. B29C 47/92

(52) U.S. Cl. 264/40.1; 264/409; 425/135

(57) ABSTRACT

Spacers suitable for installation between selected barrel sections of extruders are useful in evaluating the incidence of corrosion within the extruder. Processes for the deployment of such spacers are also disclosed.

### CROSS REFERENCE TO RELATED APPLICATIONS

This application claims the benefit of U.S. Provisional Application No. 60/591,531, filed Jul. 27, 2004.

### FIELD OF THE INVENTION

The present invention relates to apparatus suitable for installation in conventional extruders which demonstrate the occurrence of corrosion therein. More particularly the present invention relates to spacers inserted between select barrel sections of an extruder, their monitoring during extrusion runs to determine whether and to what extent corrosion occurs therealong, and processes incorporating such spacers and associated apparatus.

### BACKGROUND OF THE INVENTION

Extrusion is a very well known process for blending ingredients into polymers. Additives such as lubricants, flame retardants, heat stabilizers, colorants, impact modifiers, minerals, and reinforcing agents can be added in this manner. The polymers useful in extrusion blending are very extensive, including but not limited to polyethylene, polypropylene, polyvinyl chloride, polyamide, polyester, fluoropolymers, and acrylonitrile-butadiene-styrene polymers (ABS).

It is also well known that additives such as minerals may be dispersed in a polymer matrix, such as adding mineral, without a chemical reaction occurring between the polymer and the additive. In this case, the composition will be constant throughout the extruder. By this is meant, the lack of a chemical reaction promotes an environment in which the composition is substantially uniform within all areas of the extruder.

However in many instances some additives will react, either with other additives or with the polymer. This process can be referred to as “reactive extrusion” and in this case, the chemical composition will not be constant throughout the extruder. By this is meant, the presence of a chemical reaction promotes an environment in which the composition is no longer necessarily uniform within all areas of the extruder, but changes as chemical reaction occurs between some or all of the materials being compounded as they move through the extruder. An example of such a reaction is the well-known addition of toughening agents such as grafted rubbers or ionic polymers that can be employed to improve the toughness of polyamides. See for example U.S. Pat. No. 4,174,358 and U.S. Pat. No. 3,845,163.

Moreover it is well understood that the addition of grafted rubbers or ionic polymers increases the melt viscosity of the resulting polymer blend. It has been recently disclosed that the addition of an organic acid can decrease the molecular weight of said toughened polyamide, imparting higher flow characteristics to the polyamide blend without adversely affecting the toughness thereof. (U.S. Patent Application 20030018135)

However, the addition of organic acids can, at the temperatures normally found during polyamide compounding, cause unacceptably high rates of corrosion in the compounding equipment. This discloses a method and apparatus for accurately measuring corrosion that occurs during equipment operation.

It is well known that materials decrease in viscosity as their temperature is increased above the melting point. In the case of compounding extruders, such low viscosity materials could penetrate cracks in the anti-wear lining materials or penetrate the joint areas between adjacent barrel sections or screw bushings. This is undesirable, as the acid could remain there, even after the completion of compounding runs that used added organic acid. The presence of the acid, the high temperature needed for extrusion of polyamides, the wear characteristics of the polymer blend and extruder, and the moisture from the air or from the feed resins combine to produce rapid corrosion of the extruder barrels and screw elements.

Solutions to the corrosion problem could include changing to more corrosion resistant extruder barrels and screw elements or modifying the underlying chemical reactions to promote a less corrosive environment. More corrosion resistant materials are readily available but are more costly.

It is well known that most organic acids tend to be corrosive to steel, especially at higher temperatures. See, for example, DECHEMA Corrosion Handbook: Corrosive Agents and Their Interaction with Materials; Edited by: Dieter Behrens; Vol. 4: Alkanecarboxylic Acids, Formic Acid, Hot Oxidizing Gases, Polyols —1989; Alkanecarboxylic Acids, by L. Hasenberg; pp. 1-53; VCH Publishers.

The use of corrosion coupons to monitor corrosion is widely practiced. However, those skilled in the art will immediately recognize the problems using corrosion coupons to monitor reactive extrusion. To be effective, the flowing polymer mixture must continuously contact the corrosion coupon but, in an extruder, all the available space is taken up with the extruder shafts and screw elements.

Corrosion rates on some systems have been effectively measured by using corrosion coupons exposed to a reaction medium in an unstirred or stirred autoclave. However, as is completely apparent to those skilled in the art, the chemical composition in an autoclave does not adequately portray the changes in composition that occur along the length of a reactive extruder system. In addition, an autoclave test, whether it is stirred or static, does not accurately simulate the erosive/wear characteristics of the extrusion process, which can significantly accelerate metal loss as a result of a combination of erosion and corrosion.

It might occur to those skilled in the art to measure the corrosion rate by accurately weighing extruder barrel elements before and after exposure. However, the possibility of physical wear—rather than actual corrosion—causing changes in the weight of these elements is very real. Therefore, weight loss may not be a reliable indicator of corrosion. Because the weight of a barrel section is so great when compared to the weight loss in a test of reasonable length that tests that rely on weight change alone could result in inaccurate test results or the need for duplicate testing, which is avoided by this method.

It is therefore an object of the present invention to provide an apparatus to incorporate into extrusion equipment, which yields reliable and accurate information regarding the rate and extent of corrosion of such equipment. A feature of the present invention is its ease of incorporation into existing extrusion equipment, as it is readily “retrofitted” between barrel sections therealong. These and other objects, features and advantages of the present invention will become readily apparent upon having reference to the detailed description thereof.

### SUMMARY OF THE INVENTION

There is disclosed and claimed herein a method of measuring the corrosion rate in an extruder processing a polymer or polymer mixture, comprising
(a) fabricating spacers of test metal that match the profile of existing extruder barrel sections;
(b) measuring the spacer hole dimensions and assessing the condition and features of the spacer surfaces to be exposed before use;
(c) exposing the spacer to the extruder environment for a predetermined time; and
(d) examining the exposed spacers to determine the corrosion rate.

Apparatus is also disclosed for measuring the corrosion rate in an extruder processing a polymer or polymer mixture. This comprises spacers that substantially conform to the cross sectional outline of barrel sections of said extruder, so that the spacers are inserted between at least two of the barrel sections.

The present invention will become better understood upon having reference to the following description of the drawings herein.

### BRIEF DESCRIPTION OF THE DRAWINGS

FIG. 1 is a top view of the spacer apparatus of subject invention; and

FIGS. 2A and 2B are schematic barrel arrangements of a conventional extruder without and with the spacer apparatus in place, respectively.

### DETAILED DESCRIPTION OF THE INVENTION

It has been observed through use of the method and apparatus disclosed herein that while there are is a broad group of organic acids that can suitably be used to produce toughened polyamides with high flow characteristics, only a much smaller subset of that group can also avoid the negative consequences of high corrosion rates.

Table 1 lists the melting points from some representative organic acids.

TABLE 1

| | Melting Point |
|---|---|
| Organic Acid | (° C.) |
| Adipic acid | 152 |
| Pimelic acid | 103-105 |
| Suberic acid | 140-144 |
| Azelaic acid | 98-102 |
| Sebacic acid | 133-137 |
| Undecanedioic | 108-110 |
| acid | |
| Dodecanedioic | 130 |
| acid | |
| Valeric acid | −20 to −18 |
| Trimethylacetic | 32 |
| acid | |
| Caproic acid | −3 |
| Caprylic acid | 16.5 |
| Terephthalic acid | Sublimes |
| | above 300 |
| Isophthalic acid | 312-330 |

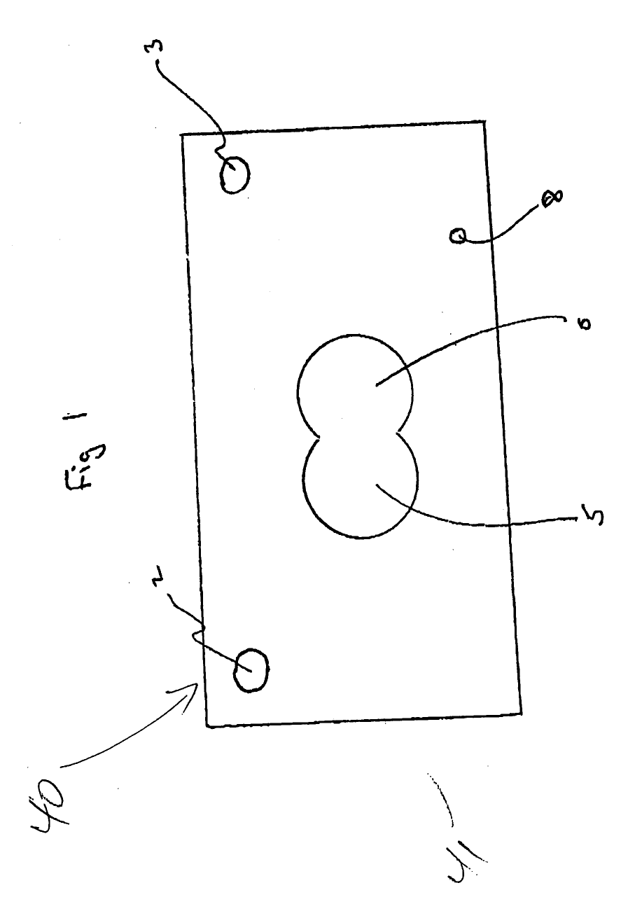

Having reference to FIG. 1, there is shown generally at 40 a spacer 41 (such as a metal plate) that has been machined to match the profile of conventional extruder barrels. Tie rods (not shown) extend the length of the extruder and are tightened from the end to hold the barrel sections together. The spacers 41 were cut with holes 2 and 3 to match the location of the tie-rod holes in the barrel sections. They were also cut with partially overlapping holes 5 and 6 to further match the barrel section of the twin screw extruder. Finally, locating pin 8 was used it insure the spacer 41 matched up precisely with the adjoining barrel sections.

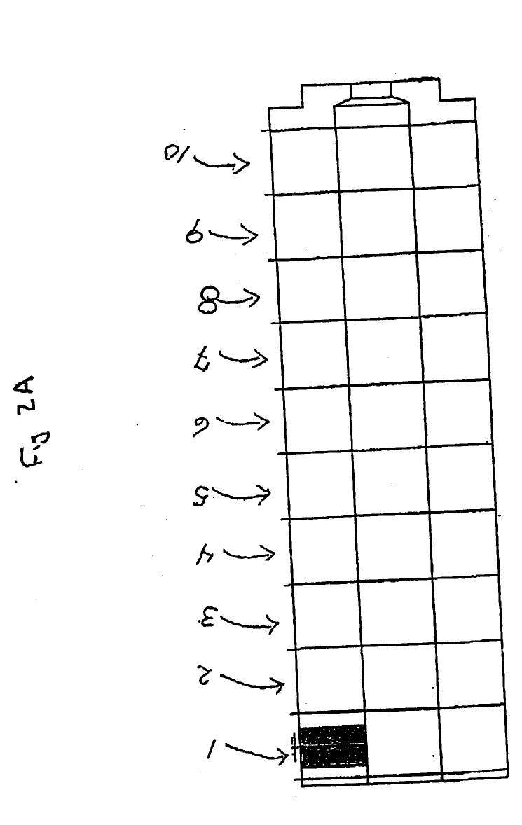

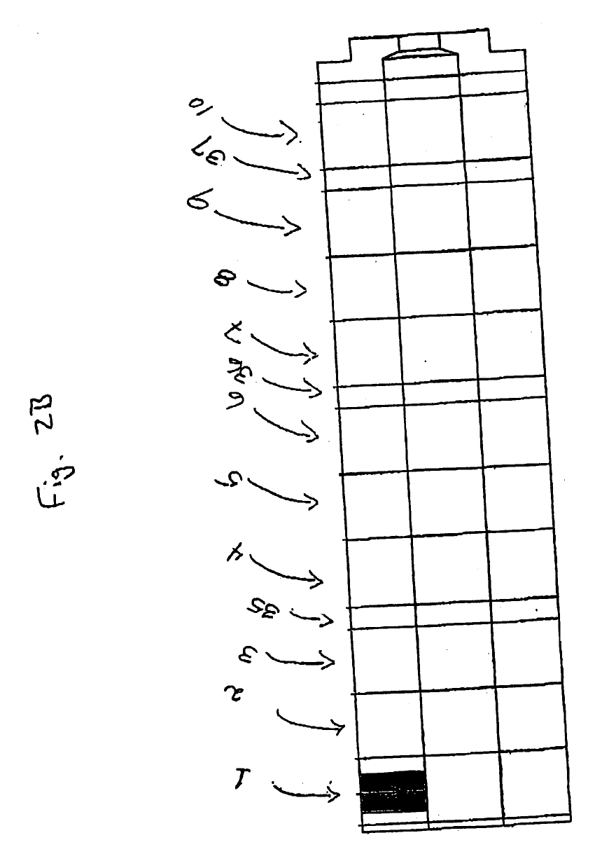

Now having reference to FIG. 2A, there is shown generally at 50 a schematic side view of a conventional extruder, such as a 30 mm W&P Extruder, with the heaters and other ancillary equipment removed. The barrel sections are placed contacting each other and held in place by tie rods (not shown). The barrel sections can be referred to by individually numbering them from the feed section of the extruder and moving to the die-end of the extruder. In this figure, they are numbered 1-10 with the feed end designated as 1 and the die end designated as 10.

Finally, having reference to FIG. 2B, there is shown the same schematic side view of an extruder as in FIG. 2A except spacer plates 35, 36, and 37 (identical to the spacer 41 depicted in FIG. 1) have been inserted between the barrel sections 3 and 4, 6 and 7, and 9 and 10, respectively. As this arrangement will make the assembled barrel ¾-inch longer, it will be readily apparent to those skilled in the art that a slightly longer tie rod is needed to properly assemble the extruder.

Experimental Procedure to Quantify Corrosion and Wear from Exposure to Process Melt

The following procedures were used as indicated further below in preparation of the Examples herein. They may be generally applied to measure amounts of wear on surfaces of spacers of the invention.

Changes in dimensional measurements of the internal surfaces of the surface in contact with the melt were used to calculate the rate of metal loss/year in mils/year (mpy). To ensure accuracy, two different techniques (labeled 1 and 2 immediately below) were used to record the dimensional measurements before and after exposure of the spacers to the polymer melt process runs. In addition, optical examination of the spacers before and after exposure were used to qualitatively confirm the degree of severity of wear and corrosion.

The important details of each of these techniques are as follows:
1. Changes in dimension using a fixed point of reference: The spacer was placed on an (x,y) axis, using the bottom left corner of the spacer as the reference point (0,0). The center points of the openings in the spacer (e.g. holes 5 and 6) were determined using a digital micrometer and the distance from the center points to specific points on the inner surface of the openings (e.g. holes 5 and 6) was measured, again using a digital micrometer. The points on the inner surface were defined by moving in a straight line from the center point to the inner surface at a specified angle relative to the x or y axis. After exposure to the extrusion process, the center points of the opening were again determined and the distance from the center points to points on the inner surface of the openings was determined, where the points on the inner surface were defined by moving in a straight line from the center point to the inner surface at the same specified angles relative to the x or y axis as were used in the initial measurement. The differences in distance before and after exposure for each of the points were used to determine the metal loss in the spacers.
2. Rates based on Average Diameter of Two Circles: The degree of metal loss from exposure to the melt was also calculated on the basis of changes in the average diameter of the two circles of the spacer. FIG. 1 shows the “figure eight” of the spacer. Measurements were made using a laser micrometer that digitally traced the diameter of each of the two circles.
3. Optical Examination: In addition to the above measurements, changes in appearance of the internal surfaces of the spacers were optically examined at magnifications of 40-50× to document signs of wear and corrosion. This examination by a trained metallurgist is critical as wear during the extruder operation could falsely indicate corrosion and vice-versa. However, it is well known to those skilled in the art that the appearance of corrosion and wear can be optically distinguished.

As will be obvious to one skilled in the art, these and other techniques can be similarly used to measure wear in single screw extruders.

### EXAMPLES

### Example 1

Example 1 illustrates the preparation of a high-flow supertough polyamide. ZYTEL® 101 is a 66-nylon, commercially available from E. I. DuPont de Nemours & Co., Inc., Wilmington, Del. Fusabond® N MF521 D is a grafted EPDM elastomer with maleic anhydride functionality and is also commercially available from DuPont. The black color concentrate is a carbon black dispersed by extrusion blending into a suitable carrier. Dodecanedecanoic acid is also available commercially from DuPont. Aluminum distearate could also be obtained from Ciba Specialty Chemicals.

During the operation for melt blending the control of ingredients feed rates was accomplished by use of loss-in-weight feeders. Prior to feeding the ingredients were first dry blended by tumbling in a drum. The mixture was then compounded by melt blending in a 30 mm Werner & Pfleiderer co-rotating twin screw extruder with a barrel temperature about 270° C. and a die temperature of about 280° C. All the ingredients were fed into the first barrel section. Extrusion was carried out with a port under vacuum. The screw speed was 250 rpm and the total extruder feed rate was 30 pounds per hour. The resulting strand was quenched in water, cut into pellets, and sparged with nitrogen until cool.

Prior to use, however, the extruder was modified by placing ¼-inch thick spacers of 4140 tool steel between barrels 3 and 4, between barrels 6 and 7, and between barrels 9 and 10. Each spacer was carefully examined and record was made of its exact weight, its dimensions as determined by using laser and standard digital measurement techniques, and especially the condition of the surface that would contact the polymer melt including that as characterized by optical microscopy.

Moreover, a nitriding procedure was conducted on the 4140 spacers, involving conventional gas nitriding. The spacers, which were already prehardened to 32 Rockwell C, were placed in a furnace under a vacuum, purged with nitrogen and hydrogen, and heated to 950° F. The parts remained at this temperature for 24 hours and were cooled while being purged only with nitrogen. This process typically imparted a surface hardness of approximately 65 RC to a depth of 0.012 to 0.015 in. Actual hardness measurements on the spacers used in the instant Examples were about 57 HRc.

In this case, the following materials were melt blended in the quantity shown in Table 2.

TABLE 2

| | Quantity |
|---|---|
| Material | (wt %) |
| Zytel ® 101 NC010 | 77.57 |
| Fusabond ® N | 17.05 |
| MF521D | |
| Black color | 4.45 |
| concentrate | |
| Dodecanedioic Acid | 0.65 |
| Stabilizers and | 0.28 |
| lubricants | |
| TOTAL | 100.00 |

The extrusion run continued, running for 10 days. Each day, the extruder was run for between 6 1/2 to 7 hours. Following the 10 days of operation, the extruder was disassembled. The spacers were burned out in a conventional manner, as is readily understood by those having skill in the field. The spacers were then examined by noting their weight and dimensions and by examining the surface with an optical microscope and/or scanning electron microscope, all as described in the procedural description set forth above. A qualified person having experience in the technology then classified the features observed on the spacer surface exposed to the process environment as resulting from corrosion or wear. If corrosion was determined to be the mechanism causing change in weight and dimensions, a corrosion rate was calculated from the dimensional changes that were measured after exposure. If wear was determined to be the mechanism causing change in weight and dimensions, that location was excluded from the measurement of corrosion rate. The results from this test are recorded in Table 3.

TABLE 3

| | Corrosion | Corrosion |
|---|---|---|
| | rate¹ | rate¹ |
| Spacer location | Left side | Right Side |
| Between barrels | 379-487 mpy | 183-291 mpy |
| 3-4 | | |
| Between barrels | 9-117 mpy | 0-74 mpy |
| 6-7 | | |
| Between barrels | 25-133 mpy | 0-100 mpy |
| 9-10 | | |

Note:
Data in Table 3 is based on measurements taken at 10 points around the openings of the spacer. The designations “left” and “right” are relative to the direction of polymer flow.

### Example 2

The test in Example 1 was repeated except terephthalic acid was substituted for dodecanedioic acid. The composition shown in Table 4 was used. The weight percentage of terephthalic acid was selected to ensure that the amount used was approximately equal to the amount of dodecanedioic acid used in the Example 1 on a molar basis relative to the total weight of the composition.

TABLE 4

| | Quantity |
|---|---|
| Material | (wt %) |
| ZYTEL ®® 101 | 77.75 |
| NC010 | |
| Fusabond ® N | 17.05 |
| MF521D | |
| Black color | 4.45 |
| concentrate | |
| Terephthalic Acid | 0.47 |
| Stabilizers and | 0.28 |
| lubricants | |
| TOTAL | 100.00 |

The extrusion run continued for 10 days. Each day, the extruder was run for between 6½ to 7 hours. Following the 10 days of operation, the extruder was disassembled. The spacers were burned out and examined by noting their dimensions and by examining the surface with an optical microscope. Again as in Example 1, an expert in the technology classified the features observed on the spacer surface exposed to the process environment as resulting from corrosion or wear. If corrosion was determined to be the mechanism causing change in weight and dimensions, a corrosion rate was calculated from the dimensional changes that were measured after exposure, using the techniques described as above. If wear was determined to be the mechanism causing change in weight and dimensions, that location was excluded from the measurement of corrosion rate. The results from this test are recorded in Table 5.

TABLE 5

| | Corrosion | Corrosion |
|---|---|---|
| | rate¹ | rate¹ |
| Spacer location | Left side | Right Side |
| Between barrels | 0-21 mpy | 0-15 mpy |
| 3-4 | | |
| Between barrels | 0 mpy | 0 mpy |
| 6-7 | | |
| Between barrels | 0-29 mpy | 0-3 mpy |
| 9-10 | | |

Note:
Data in Table 5 based on measurements taken at 8 points around the openings of the spacer.

Measurements at 10 points were made for each spacer for Example 1 and measurements at eight points were made for each spacer for Example 2 and the range of results is reported in Table 6. Due to experimental error, low rates of metal loss were sometimes calculated to be negative. Negative rates are reported as zero in Table 5. The surfaces of the openings in the spacers were also visually inspected at a 40-50 fold magnification. Visual inspection showed that the spacers used in Example 2 showed significantly less corrosion than those used in Example 1.

It will be noted by those skilled in the art that additional surface characterization techniques such as scanning electron microscopy and surface profilometry could be used without departing form the spirit of this invention.

1. A method of measuring the corrosion rate in an extruder processing a polymer or polymer mixture, comprising
(a) fabricating spacers of test metal that match the profile of existing extruder barrel sections;
(b) measuring the spacer hole dimensions of the spacer and assessing the condition and features of the spacer surfaces to be exposed before use;
(c) exposing the spacer to the extruder environment for a predetermined time; and
(d) examining the exposed spacers to determine the corrosion rate.

2. A method of claim 1 when dimensions of said spacer hole are measured by a laser micrometer.

3. Apparatus for measuring the corrosion rate in an extruder processing a polymer or polymer mixture comprising at least one spacer that substantially conform to the cross sectional outline of barrel sections of said extruder, so that said one or more spacers are inserted between at least two of the barrel sections.
